(19) United States
(12) Patent Application Publication
(10) Pub. No.: US 2015/0035963 A1
(43) Pub. Date: Feb. 5, 2015

(54) Dual-Camera Apparatus And Method For Deriving Dimensional Measurements

(71) Applicant: Eyelation, LLC, Tinley Park, IL (US)

(72) Inventors: Bradley Kirschner, Tinley Park, IL (US); Brandon Hass, Chicago, IL (US); Kiet Pham, Bolingbrook, IL (US)

(21) Appl. No.: 14/311,890

(22) Filed: Jun. 23, 2014

Related U.S. Application Data
(60) Provisional application No. 61/838,304, filed on Jun. 23, 2013.

(51) Int. Cl. G01B 11/02; H04N 5/225; H04N 17/00; H04N 5/247

(52) U.S. Cl. CPC G01B 11/02; H04N 5/247; H04N 5/2252; H04N 17/002
USPC 348/78; 348/135; 348/77

(57) ABSTRACT

A dual-camera apparatus derives dimensional measurements of an object. The apparatus comprises a pair of digital cameras each comprising a lens and capable of producing an image of the object. A ratio of known distance units to pixels is established for the apparatus and applied to images generated by each of the digital cameras. The lenses are spaced apart at a first known distance. In operation, the first known distance and the established ratio provide a trigonometric basis for ascertaining distances between at least two features on the object. A calibration template can be used to establish the ratio of known distance units to pixels. The object can be a human subject, and the at least two features can be associated with the human subject's eyes, the human subject's feet, and/or other human body parts.

### CROSS-REFERENCE TO RELATED APPLICATION

This application is related to and claims priority benefits from U.S. provisional patent application Ser. No. 61/838,304 filed on Jun. 23, 2013. The '304 provisional application is hereby incorporated by reference herein in its entirety.

### FIELD OF THE INVENTION

The present invention relates to measurement devices and, in particular, to an apparatus that employs two cameras space apart at a known distance, which measures and facilitates the determination of the dimensions between two or more features of an object or a human subject.

### BACKGROUND OF THE INVENTION

In fitting apparel to be worn by persons performing work in potentially hazardous settings, such as a factory, plant or construction site, it is important to have the ability to conveniently measure the dimensions of the workers' body parts on which the apparel is to be worn. The traditional process of fitting employees with personal protective equipment (PPE) is inefficient and cumbersome. An employee must first interact with a human resources personnel, safety specialists and/or outside vendors to ascertain the required PPE and options for selecting the individual apparel components. For example, a particular factory may require a specific type of safety glasses and/or hard-toed shoes.

In the traditional process, once the employer specifies the required complement of PPE, the employee normally has choices regarding the particular design aspects of the individual components. In the case of hard-toed protective shoes, for example, an employee would normally select their size, color and style. One way for an employee to be outfitted with PPE is to visit a company or commercial store to be measured and then make selections. Another way some companies may employ is to direct their employees to websites offering selections once the appropriate dimensional measurements of the employee have been taken.

Recently, manufacturing facilities and construction sites have used systems that employ a conventional digital camera to ascertain the dimensional measurements of an employee. Since those conventional systems only employ a single camera, a template with known indicia of distances is placed on or near the human subject during the measurement process. In this way, the dimensional measurements of the human subject's body parts on which the PPE is to be worn can be accurately derived.

### SUMMARY OF THE INVENTION

The foregoing and other shortcomings of conventional measuring techniques are overcome by a dual-camera apparatus for deriving dimensional measurements of an object. The apparatus comprises a pair of digital cameras each comprising a lens and capable of producing an image of the object. The apparatus has established therefor a ratio of known distance units to pixels in images generated by each of the digital cameras. The lenses are spaced apart at a first known distance. In operation, the first known distance and the established ratio provide a trigonometric basis for ascertaining distances between at least two features on the object.

In a preferred apparatus embodiment, the object is a human subject. The at least two features can be associated with the human subject's eyes, the human subject's feet, and/or other human body parts.

A system for deriving dimensional measurements of an object comprises:
(a) a housing;
(b) a pair of digital camera lenses encased within the housing and capable of producing an image of the object external to the housing, the lenses spaced apart at a first known distance; and
(c) a calibration template for establishing a ratio of known distance units to pixels in images generated by each of the digital cameras.

In operation, the first known distance and the established ratio provide a trigonometric basis for ascertaining distances between at least two features on the object.

Shortcomings of conventional measuring techniques are also overcome by a method for deriving dimensional measurements of an object. The method comprises:
(a) spacing apart a pair of digital cameras at a first known distance, each of the digital cameras comprising a lens and capable of producing an image of the object;
(b) generating images from each of the digital cameras of a calibration template, thereby establishing a ratio of known distance units to pixels in images generated by the digital cameras; and
(c) ascertaining distances between at least two features on the object using trigonometric calculations based upon the first known distance and the established ratio.

In a preferred method embodiment, the object is a human subject. The at least two features can be associated with the human subject's eyes, the human subject's feet, and/or other body parts.

### BRIEF DESCRIPTION OF THE DRAWINGS

FIG. 1 is an isometric view of the present dual-camera apparatus for deriving dimensional measurements.

FIG. 2 is a front view of the apparatus illustrated in FIG. 1, and which shows the two cameras, spaced apart at a known distance, employed in the apparatus.

FIG. 3 is a back view of the apparatus illustrated in FIGS. 1 and 2, and showing in particular the clip for mounting the apparatus on a computer screen or other upright surface.

FIG. 4 is a side view of the apparatus illustrated in FIGS. 1-3, and showing, in particular, the calibration setup for determining the distance from a reference plane to the plane of the housing front face containing the dual camera lenses.

FIG. 5 is an enlarged front view of the dual-camera apparatus in which the fixed, known distance between the cameras is shown, as well as the alignment of the horizontal and vertical axes associated with the cameras.

FIG. 6 is schematic diagram illustrating a template or ruler for converting a distance measurement to a number of pixels in a digital camera device.

### DETAILED DESCRIPTION OF PREFERRED EMBODIMENT(S)

Turning first to FIG. 1, the present dual-camera apparatus 10 includes a housing 11 in which digital cameras with lenses 12a and 12b are encased. Digital cameras lenses 12a, 12b are spaced apart at a fixed, known distance. An articulated clip 16 extends from housing 11 and is configured to be mounted and retained on the top edge of a computer screen or other thin, upright structure (not shown). Fasteners, one of which is denoted in FIG. 1 as threaded fastener 14, when removed provide access to the interior of housing 11, which contains the wires and other customary electronic components to transmit electrical signals from apparatus 10 to an operatively connected computer (not shown).

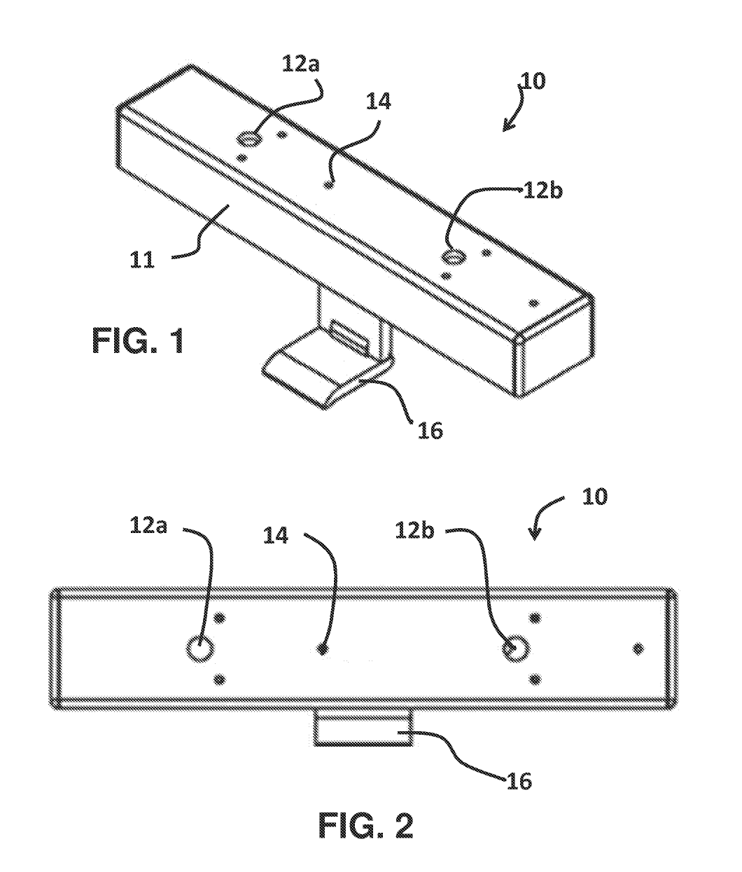

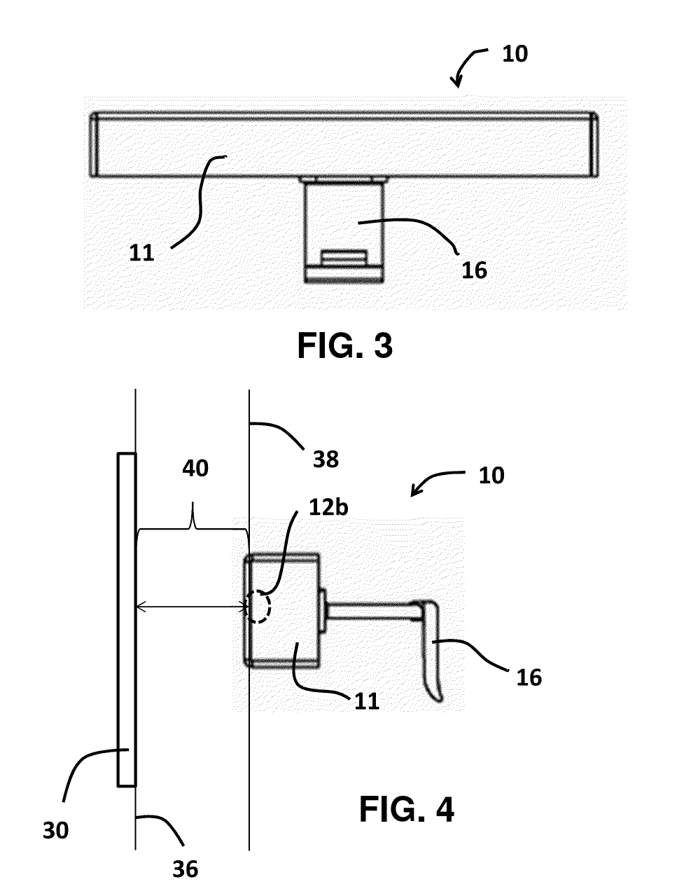

FIG. 2 shows a front view of dual-camera apparatus 10, also showing digital camera lenses 12a, 12b encased in housing 11, as well as mounting clip 16 and fastener 14. Similarly, FIG. 3 is a back view of apparatus 10 showing housing 11 and mounting clip 16.

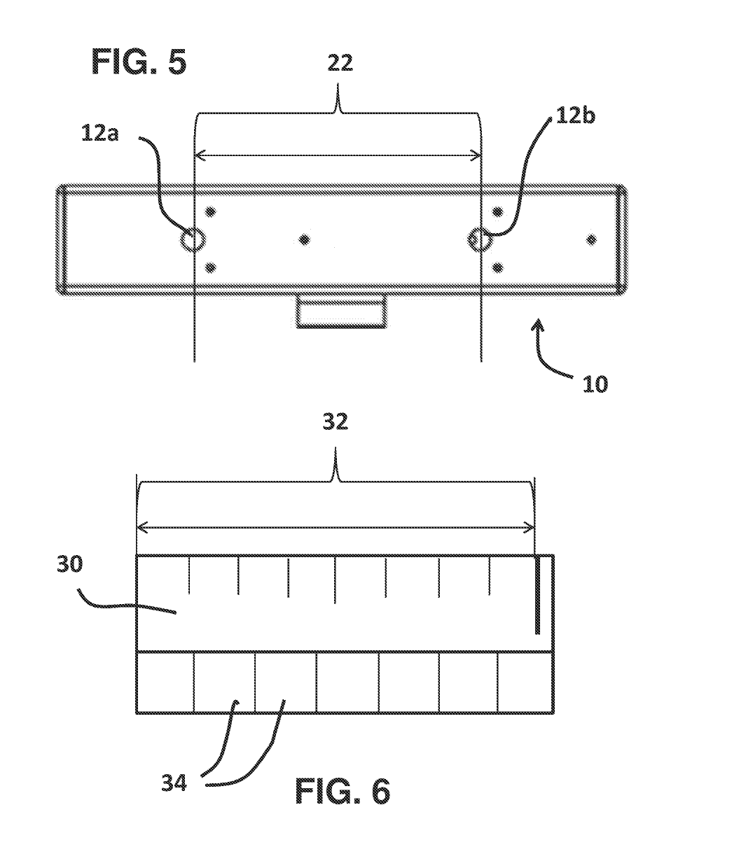

As shown in FIGS. 4 and 5, dual-camera apparatus 10 allows for a single calibration to be performed during the manufacturing or installation process. Once calibrated, apparatus 10 can remain in a calibrated state for long durations. The calibration process includes the correlation of pixels to standard (for example, metric and/or English) dimensional units, as shown in the calibration ruler or template 30, in which a known length 32 is correlated to a number of pixels 34.

Using the distances established for dual-camera apparatus 10 (namely, known distance 22 in FIG. 5 and distance 40 in FIG. 4 derived from images taken by the digital cameras of the calibration template), horizontal and vertical axes can be established. Distance 22, as shown in FIG. 5, is the known distance between the centerlines of camera lenses 12a, 12b. As shown in FIG. 4, distance 40 can be calculated as the distance between apparatus reference plane 38 and parallel calibration template reference plane 36. Apparatus reference plane 38 is established by the front face of housing 11, which is assumed to be co-extensive with the front surface of the camera lenses, one of which is shown in phantom lines in FIG. 4 as camera lens 12b. Template reference plane 36 is established by face of calibration template 30.

The apparatus can thus compensate for zooming in/out relative to an object, as well as rotational deviations from the calculated horizontal and vertical axes, by reference to the distance values established in the initial calibration process.

In the case of fitting an employee with personal protective equipment, a subject's body features associated with the apparel as worn are measured and derived from the digital camera images. The images of the subject can be accurately reconfigured (that is, rotated and/or zoomed in/out) to match the scale of a fixed digital display of the apparel being fitted.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A dual-camera apparatus for deriving dimensional measurements of an object, the apparatus comprising a pair of digital cameras each comprising a lens and capable of producing an image of said object, the apparatus having established therefor a ratio of known distance units to pixels in images generated by each of said digital cameras, said lenses spaced apart at a first known distance, whereby said first known distance and said established ratio provide a trigonometric basis for ascertaining distances between at least two features on said object.

2. The apparatus of claim 1, wherein said object is a human subject.

3. The apparatus of claim 2, wherein said at least two features are associated with said human subject's eyes.

4. The apparatus of claim 2, wherein said at least two features are associated with said human subject's feet.

5. A system for deriving dimensional measurements of an object comprising:
(a) a housing;
(b) a pair of digital camera lenses encased within said housing and capable of producing an image of said object external to said housing, said lenses spaced apart at a first known distance; and
(c) a calibration template for establishing a ratio of known distance units to pixels in images generated by each of said digital cameras;
whereby said first known distance and said established ratio provide a trigonometric basis for ascertaining distances between at least two features on said object.

6. The system of claim 5, wherein said object is a human subject.

7. The system of claim 6, wherein said at least two features are associated with said human subject's eyes.

8. The system of claim 6, wherein said at least two features are associated with said human subject's feet.

9. A method for deriving dimensional measurements of an object comprising:
(a) spacing apart a pair of digital cameras at a first known distance, each of said digital cameras comprising a lens and capable of producing an image of said object;
(b) generating images from each of said digital cameras of a calibration template, thereby establishing a ratio of known distance units to pixels in images generated by said digital cameras; and
(c) ascertaining distances between at least two features on said object using trigonometric calculations based upon said first known distance and said established ratio.

10. The method of claim 9, wherein said object is a human subject.

11. The method of claim 10, wherein said at least two features are associated with said human subject's eyes.

12. The method of claim 10, wherein said at least two features are associated with said human subject's feet.
